(19) United States
(12) Patent Application Publication
(10) Pub. No.: US 2013/0218891 A1
(43) Pub. Date: Aug. 22, 2013

(54) CONTROL METHOD FOR HARMFUL CONTENTS IN YOUTH AND TEENAGERS

(71) Applicant: Electronics and Telecommunications Research Institute, (US)

(72) Inventors: Jae Deok LIM, Daejeon (KR); Byeong Cheol CHOI, Daejeon (KR); Seung Wan HAN, Gwangju (KR)

(73) Assignee: Electronics and Telecommunications Research Institute, Daejeon (KR)

(21) Appl. No.: 13/766,743

(22) Filed: Feb. 13, 2013

(30) Foreign Application Priority Data
Feb. 16, 2012 (KR) 10-2012-0015697

(51) Int. Cl. G06F 17/30

(52) U.S. Cl. CPC G06F 17/30286
USPC 707/736

(57) ABSTRACT

The present invention provides a method of remotely controlling harmful contents including: storing connection information of a managed-terminal and connection information of a managing-terminal in a database unit by using an administrative server, by transmitting the connection information to the administrative server by using the managed-terminal; analyzing, by the managed-terminal, contents stored in the managed-terminal and creating an analysis result on the contents; requesting, by the managed-terminal, the connection information of the managing-terminal to the administrative server; transmitting, by the managed-terminal, the analysis result on the contents to the managing-terminal by using the connection information of the managing-terminal transmitted from the managing server; and processing, by the managed-terminal, the contents in accordance with a processing request for the contents transmitted from the managing-terminal.

### CROSS-REFERENCES TO RELATED APPLICATIONS

The present application claims priority under 35 U.S.C 119(a) to Korean Application No. 10-2012-0015697, filed on Feb. 16, 2012, in the Korean Intellectual Property Office, which is incorporated herein by reference in its entirety set forth in full.

### BACKGROUND

Exemplary embodiments relate to a method of remotely managing harmful contents using Apps, and more particularly, to a control method for harmful contents in youth and teenagers that remotely controls harmful contents in contents stored in a managed-terminal from a managing-terminal.

Recently, as smart terminals such as a smart phone and a smart pad are actively used and the routes of providing contents are varied, using multimedia contents in mobile devices is gradually increasing.

The contents include many obscene contents that are harmful to teenagers, such that it is increasingly necessary to manage obscene contents in terminals that teenagers use.

However, when parents individually check terminals of their juvenile children, this may cause unnecessary friction and trouble for both the parents and children.

Therefore, it was necessary to remove the trouble and effectively manage obscene contents in the terminals of juvenile children.

There is Korean Patent Publication No. 10-2009-0019329 (2007 Aug. 20) titled ‘method for blocking objectional contents and portable communication terminal for blocking objectional contents, as one of the technical field of the present invention.

### SUMMARY

An embodiment of the present invention is directed to provide a method of remotely managing harmful contents which makes it possible to analyze contents stored in a managed-terminal and to remotely control harmful contents stored in the managed-terminal from a managing-terminal in accordance with the analysis result.

An embodiment of the present invention relates to a method of remotely controlling harmful contents, including: storing connection information of a managed-terminal and connection information of a managing-terminal in a database unit by using an administrative server, by transmitting the connection information to the administrative server by using the managed-terminal; analyzing, by the managed-terminal, contents stored in the managed-terminal and creating an analysis result on the contents; requesting, by the managed-terminal, the connection information of the managing-terminal to the administrative server; transmitting, by the managed-terminal, the analysis result on the contents to the managing-terminal by using the connection information of the managing-terminal transmitted from the managing server; and processing, by the managed-terminal, the contents in accordance with a processing request for the contents transmitted from the managing-terminal.

The method further includes storing the analysis result on the contents to the database unit by transmitting the analysis result to the administrative server, by using the managed-terminal.

The processing of contents restricts access to harmful contents.

The processing of contents deletes harmful contents.

The processing of contents permits access to harmless contents.

The managed-terminal prevents harmful contents from being listed in a file list.

The managed-terminal updates the connection information of the managed-terminal every time a network area is changed, by transmitting the connection information to the administrative server.

Another embodiment of the present invention relates to a method of remotely controlling harmful contents, including: storing connection information of a managing-terminal and connection information of a managed-terminal in a database unit by using an administrative server, by transmitting the connection information to the administrative server by using the managing-terminal; requesting, by the managing terminal, the connection information of the managed-terminal to the administrative server, when the managing terminal receives an analysis result on contents stored in the managed-terminal from the managed-terminal; and requesting, by the managing terminal, the managed-terminal to process the contents in accordance with the analysis result on the contents by using the connection information of the managed-terminal transmitted from the administrative server.

The requesting of processing the contents requests access restriction to harmful contents.

The requesting of processing the contents requests deletion of harmful contents.

The requesting of processing the contents requests permission to access harmless contents.

The managing-terminal updates the connection information of the managing-terminal every time a network area is changed, by transmitting the connection information to the administrative server.

The present invention provides an environment where juvenile children can soundly use a smart terminal by preventing the juvenile children to be exposed to harmful contents.

Further, the present invention makes it possible to friction and trouble that may be caused when directly checking the terminals of juvenile children, through remote control.

### BRIEF DESCRIPTION OF THE DRAWINGS

The above and other aspects, features and other advantages will be more clearly understood from the following detailed description taken in conjunction with the accompanying drawings, in which:

FIG. 1 is a block configuration diagram of an apparatus deviced for remotely managing harmful contents in accordance with an embodiment of the present invention;

FIG. 2 is a flowchart of a method of remotely managing harmful contents in accordance with an embodiment of the present invention;

FIG. 3 is a flowchart illustrating a process of registering connection information of a managed-terminal in accordance with an embodiment of the present invention;

FIG. 4 is a flowchart illustrating a process of registering connection information of a managing-terminal in accordance with an embodiment of the present invention;

FIG. 5 is a flowchart illustrating a process of analyzing harmful contents with a managed-terminal and transmitting the analysis result to a managing-terminal in accordance with an embodiment of the present invention; and

FIG. 6 is a flowchart illustrating a process of managing a managed-terminal in accordance with an embodiment of the present invention.

### DESCRIPTION OF SPECIFIC EMBODIMENTS

Hereinafter, a method of remotely controlling harmful contents in accordance with an embodiment of the present invention will be described in detail with reference to the accompanying drawings. The thicknesses of lines or sizes of components illustrated in the drawings may be exaggerated for the clearness and convenience of the following description. Further, the terminologies described below are terminologies determined in consideration of the functions in the present invention and may be construed in different ways by the intention of users and operators. Therefore, the definitions of the thereof should be construed based on the contents throughout the specification.

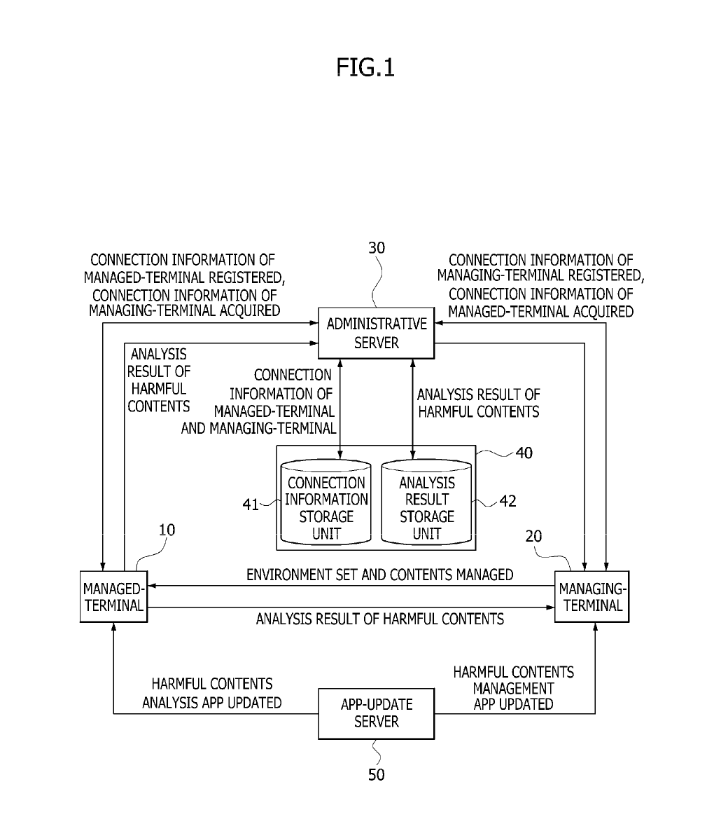

FIG. 1 is a block configuration diagram of an apparatus deviced for remotely managing harmful contents in accordance with an embodiment of the present invention.

An apparatus deviced for remotely managing harmful contents in accordance with an embodiment of the present invention, as illustrated in FIG. 1, includes a managed-terminal 10, a managing-terminal, an administrative server 30, a database unit 40, and an App-update server 50.

For reference, the harmful contents generally imply herein multimedia contents such as obscene contents or violent contents which are harmful to juvenile children and the like, and contents that are harmful to teenagers.

The managed-terminal 10 is a smart terminal that juvenile children and the like carry and use, in which a harmful contents analysis App for harmful contents analysis is loaded and executed.

The harmful contents analysis App, which is an application operated in the managed-terminal 10, is activated at a set time or in accordance with an execution order, analyzes whether the contents stored in the managed-terminal 10 is harmful and transmits the analysis result to the managing-terminal 20, and processes harmful contents in accordance with a processing request transmitted from the managing-terminal 20. Further, the harmful contents analysis App includes various environment setting functions for operating the App, such as the harmful contents management App information for transmitting the analysis result, the password of accessing the App, and lock harmful contents analysis deletion.

For reference, the analysis result include any one or more of the total number of analyzed contents, the analysis statistical information on the number of contents analyzed as obscene contents, and the thumbnail information on the contents, for example, the thumbnail image information for rechecking the analysis result.

The managing-terminal 20 is a smart terminal that parents, a guardian and the like carry and use, in which a harmful contents management App for harmful contents management is loaded and executed.

The harmful contents management App, which is an application operated in the managing-terminal 20, receives the analysis result on the contents in the managed-terminal 10 and remotely processes and manages harmful contents stored in the managed-terminal 10. Further, the harmful contents management App includes various environment setting functions such as the information on the managed-terminal 10 and a method of processing harmful contents.

The administrative server 30 stores the connection information for connecting the managing-terminal 20 with the managed-terminal 10 and selectively stores and manages the analysis result on contents in the database unit 40, if necessary.

The connection information is a variety of information for connecting the managing-terminal 20 with the managed-terminal 10, and for example, includes the IP (Internet Protocol) information and the phone numbers of the managing-terminal 20 and the managed-terminal 10.

Therefore, managing-terminal 20 is connected with the managed-terminal 10 by using the connection information of the managed-terminal 10 and the managed-terminal 10 is connected with the managing-terminal 20 by using the connection information of the managed-terminal 10, such that it is possible to transmit/receive information such as the analysis result on harmful contents and manage harmful contents.

In particular, the administrative server 30 manages the lattermost connection in formation in real time because the managed-terminal 10 frequently changes the connection information, that is, the IP information in accordance with the network environment.

For this process, when the managing-terminal 20 or the managed-terminal 10 is moved to another network area and the IP information is changed, the harmful content analysis App or the harmful contents management App senses the change in network area and registers the own changed IP information on the administrative server 30 and the administrative server stores the changed IP information in a connection information storage unit 41 of the database unit 40 to update connection information into the lattermost connection information.

As described above, it is possible to ensure communication between the managed-terminal 10 and the managing-terminal 20 by storing and managing the lattermost connection information.

Further, the administrative server 30 selectively stores the analysis result on contents created in the managed-terminal 10 to an analysis result storage unit 42, if necessary, for example, selection of the administrator or the user who operates the administrative server 30. The analysis result on the stored contents is used to recover the analysis result on the managed-terminal 10 or provide additional information such as the analysis result statistics, when being deleted from the managed-terminal 10, for example, by reinstalling the harmful contents management App.

The database unit 40 includes the connection information storage unit 41 configured to store the connection information of the managed-terminal 10 and the connection information of the managing-terminal 20 and the analysis result storage unit 42 configured to stores the analysis result on the managed-terminal 10.

The App-update server 50 updates the harmful contents analysis App loaded on the managed-terminal 10 and the harmful contents management App loaded on the managing-terminal 20. In particular, when the applications of the harmful contents analysis App and the harmful contents management App are updated for improving the functions or enhancing the safety, the corresponding Apps are updated.

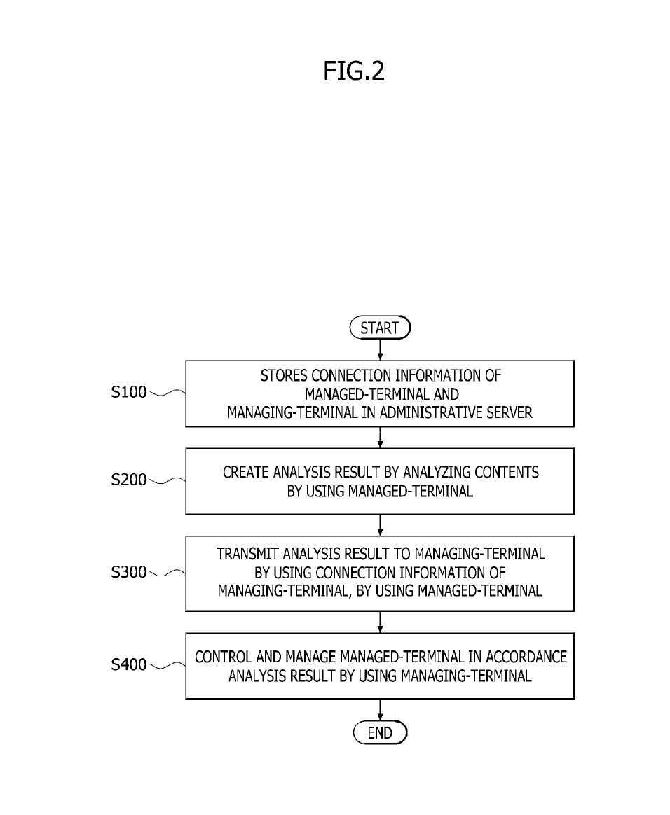

Hereinafter, a method of remotely managing harmful contents in accordance with an embodiment of the present invention will be described in detail with reference to FIGS. 2 to 5.

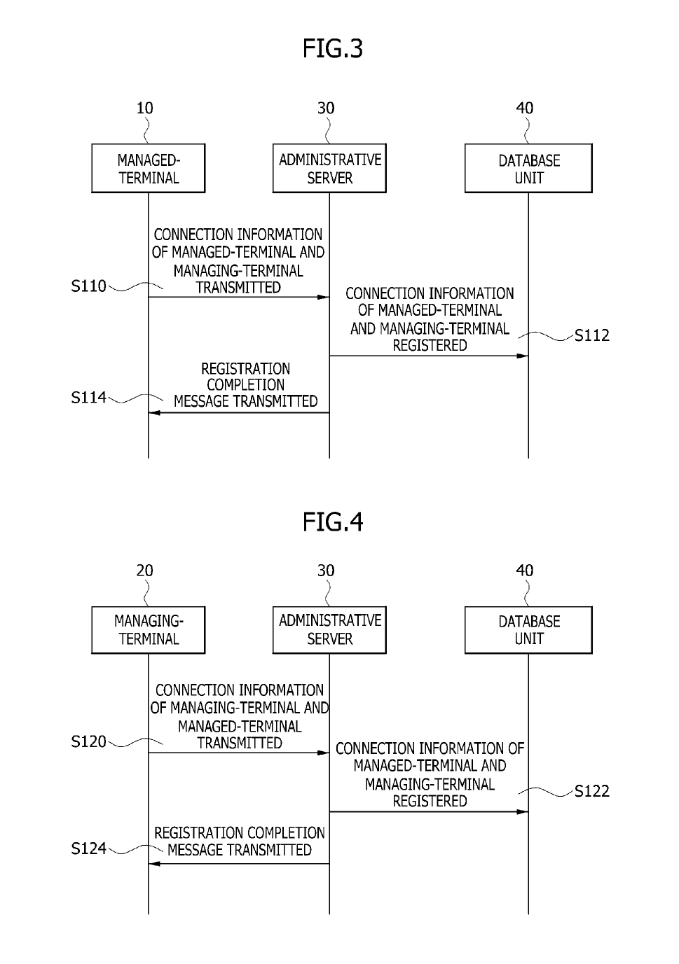

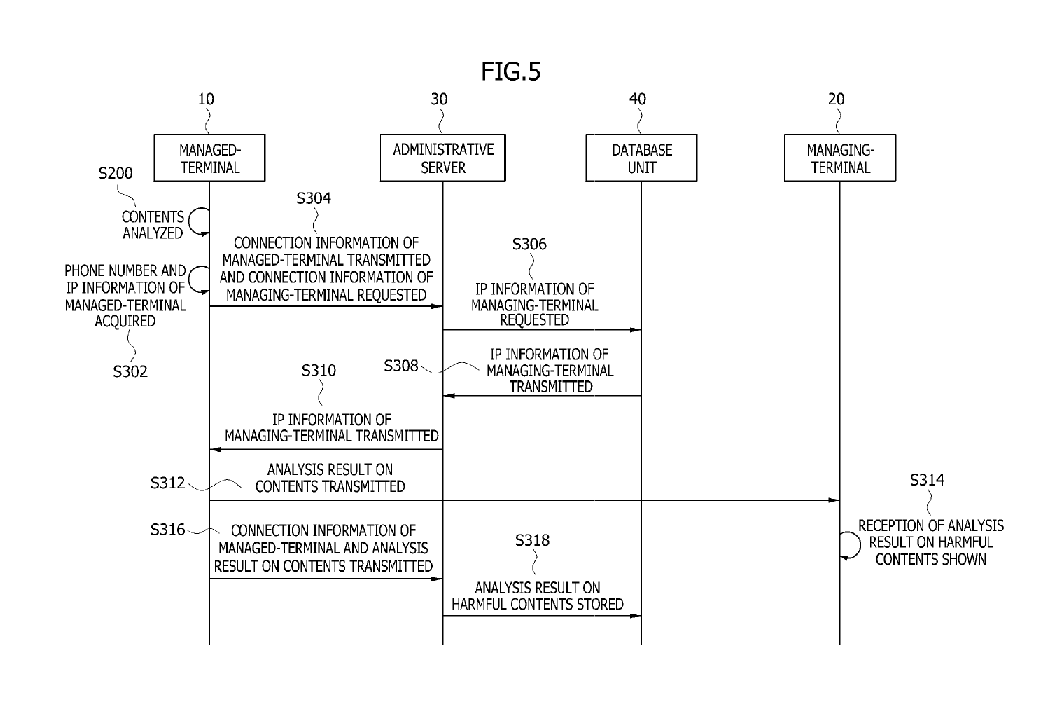

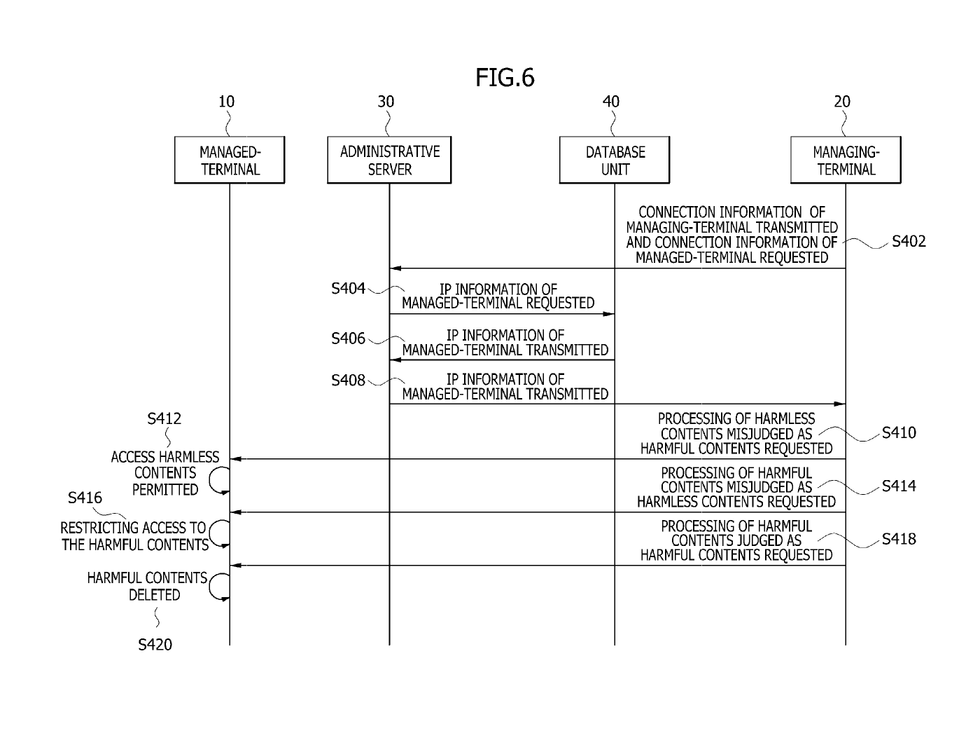

FIG. 2 is a flowchart of a method of remotely managing harmful contents in accordance with an embodiment of the present invention, FIG. 3 is a flowchart illustrating a process of registering connection information of a managed-terminal in accordance with an embodiment of the present invention, FIG. 4 is a flowchart illustrating a process of registering connection information of a managing-terminal in accordance with an embodiment of the present invention, FIG. 5 is a flowchart illustrating a process of analyzing harmful contents with a managed-terminal and transmitting the analysis result to a managing-terminal in accordance with an embodiment of the present invention, and FIG. 6 is a flowchart illustrating a process of managing a managed-terminal in accordance with an embodiment of the present invention.

A method of remotely managing harmful contents in accordance with an embodiment of the present invention is described as illustrating in FIG. 2.

First, the managed-terminal 10 and the managing-terminal 20 transmit their connection information to the administrative server 30 and the administrative server 30 registers the connection information of the managed-terminal 10 and the connection information of the managing-terminal 20 onto the connection information storage unit 41 of the database unit 40 (S100).

The process of registering the connection information of the managed-terminal 10, as illustrated in FIG. 3, attempts connection to the administrative server 30 from the managed-terminal 10. This may be attempted in various ways for the convenience of use, for example, performing the connection simultaneously with inputting the connection information of the managing-terminal 20 in the harmful contents analysis App.

The managed-terminal 10 transmits the registration message of the managed-terminal 10 to the administrative server 30, when being connected with the administrative server 30 (S110). In this process, the managed-terminal 10 transmits the phone numbers of the managing-terminal 20 and the managed-terminal 10 and the IP information of the present managed-terminal 10 to the administrative server 30, for communication between the managed-terminal 10 and the managing-terminal 20.

The administrative server 30 receives the registration message of the managed-terminal 10 and stores the connection information of the corresponding managed-terminal 10 to the connection management database unit 40 (S112).

Thereafter, a registration completion message is transmitted to the managed-terminal 10 (S114), thereby finishing registering the connection information of the managed-terminal 10.

Next, the process of registering the connection information of the managing-terminal 20 is similar to the process of registering the connection information of the managed-terminal 10.

Referring to FIG. 4, the managing-terminal 20 attempts connection to the administrative server 30. This may be attempted in various ways for the convenience of use, for example, performing the connection simultaneously with inputting the connection information of the managed-terminal 10.

The managing-terminal 20 transmits the registration message of the managing-terminal 20 to the administrative server 30, when being connected with the administrative server 30 (S120). In this process, the managing-terminal 20 transmits the phone numbers of the managing-terminal 20 and the managed-terminal 10 and the IP information of the present managing-terminal 20 to the administrative server 30, for communication between the managing-terminal 20 and the managed-terminal 10.

The administrative server 30 receives the registration message of the managing-terminal 20 and stores the connection information of the corresponding managing-terminal 20 to the connection information storage unit 41 (S122).

Thereafter, the administrative server 30 transmits a registration completion message to the managing-terminal 20 (S124), thereby finishing registering the connection information of the managing-terminal 20.

As described above, when registration of the connection information of the managed-terminal 10 and the managing-terminal 20 is finished, the connection information storage unit 41 associates the phone number of the managed-terminal 10, the IP information of the managed-terminal 10, the phone number of the managing-terminal 20, and the IP information of the managing-terminal 20 with each other and manage them.

In this case, the connection information is obviously registered in the initial registration on the harmful contents analysis App and the harmful contents management App, but the connection information is performed every time the IP information is changed due to movement of the managing-terminal 20 and the managed-terminal 10 to another network area such that the lattermost IP information is kept.

Therefore, when the IP information is changed due to movement to another network area, the managed-terminal 10 and the managing-terminal 20 newly register the IP information in accordance with the changes of their changed network area onto the administrative server 30 and the administrative server 30 updates the connection information by storing the changed IP information to the connection information storage unit 41 of the database unit 40 such that the managed-terminal 10 and the managing-terminal 20 can communicate with each other.

As described above, when the connection information of the managed-terminal 10 and the managing-terminal 20 is registered, the managed-terminal analyzes the contents stored therein and creates the analysis result (S200) and transmits the analysis result to the managing-terminal 20 by using the connection information of the managing-terminal 20 (S300).

For reference, the analysis result on the contents includes identification information and contents names that allow identifying whether the contents are harmful or harmless contents.

The process of transmitting an analysis result from the managed-terminal 10 to the managing-terminal 20 will be described in detail with reference to FIG. 5.

Referring to FIG. 5, when contents analysis is finished, the managed-terminal 10 acquires the phone number and IP information of the managed-terminal 10 (S302), transmits the connection information, that is, the phone number and the IP information of the managed-terminal 10 to the administrative server 30, and request the connection information of the managing-terminal 20 (S304).

The administrative server 30 requests the IP information of the managing-terminal to the connection information storage unit 41 by using the connection information of the managed-terminal 10 (S306). In this case, the IP information of the managing-terminal 20 is the lattermost IP information according to the network area where the managing-terminal 20 is presently located.

The connection information storage unit 41 checks the phone number and the IP information in the connection information of the managed-terminal 10, extracts the IP information of the managing-terminal 20 which corresponds to the connection information, and transmits the IP information to the administrative server (S308), and the administrative server 30 transmits the IP information of the administrative server 20 which is received from the connection information storage unit 41 to the managed-terminal 10 (S310).

The managed-terminal 10 transmits the analysis result on the contents to the managing-terminal 20 by using the IP information of the managing-terminal 20 which is received from the administrative server 30.

The managing-terminal 20 illustrates a message saying that the analysis result on the contents has been received (S314) such that the administrator can recognize the analysis result on the contents stored in the managed-terminal 10.

Further, the managed-terminal 10 prevents harmful contents from being listed when checking the file list such that children cannot directly access the harmful contents. That is, the contents that are determined as harmful contents are processed as files that are not limited on the managed-terminal not to be checked.

Further, when the function of logging the analysis result on contents of the managed-terminal 10 onto a server, the connection information of the managed-terminal 10 and analysis result on the contents are additionally transmitted to the administrative server 30 (S316) and the administrative server 30 transmits and stores the analysis result of the corresponding managed-terminal 10 to the analysis result storage unit 42 by using the connection information of the corresponding managed-terminal 10 (S318).

In this case, the analysis result storage unit 42 can be used to provide additional analysis result statistics information when inquiring an old analysis result that is not managed in consideration of the terminal load of the managing-terminal 20 or recovering an analysis result deleted due to reinstallation of the harmful contents management App.

When receiving the analysis result on contents from the managed-terminal 10, as described above, the managing-terminal 20 controls and manages the contents by remotely controlling the managed-terminal 10 in accordance with the analysis result. This will be described with reference to FIG. 6.

When a management menu in the harmful contents management App is executed, the managing-terminal 20 acquires the connection information, that is, the phone number and the IP information, of the present managing-terminal 20, transmits the phone number and the IP information of the managing-terminal 20 to the administrative server 30, and requests the connection information of the managed-terminal 10 (S402).

The administrative server requests the IP information of the managed-terminal 10 from the connection information storage unit 41 by using the connection information of the managing-terminal 20 transmitted from the managing-terminal 20.

The connection information storage unit 41 checks the phone number and the IP information in the connection information of the managing-terminal 20 and transmits the IP information of the managed-terminal 10 which corresponds to the phone number and the IP information to the administrative server 30 (S406).

The administrative server 30 transmits the IP information of the managed-terminal received from the connection information storage unit 41 to the managing-terminal 20 (S408).

When receiving the IP information of the managed-terminal 10 from the administrative server 30, the managing-terminal 20 remotely controls the contents stored in the managed-terminal 10 in accordance with the analysis result received from the managed-terminal 10, in which it is possible to checks summarized information such as the analysis date and the analysis result statistics information on the contents and correct errors in the analysis result through the thumbnail information that allows checking the contents, for example, the thumbnail image information.

Further, an access permission process is requested for harmless contents that are misjudged as harmful contents (S410) and the managed-terminal 10 requested to process access permission lists the harmless contents, which are misjudged as harmful contents that have been process as not being in the managed-terminal 10, and permits access (S412).

On the contrary, an access restriction process is requested for harmful contents that are misjudged as harmless contents (S414) and the managed-terminal 10 requested to restrict access processes the harmful contents misjudged as harmless contents in the managed-terminal 10 not to be illustrated in the file list and restricts direct access to the managed-terminal 10 (S416). That is, the harmful contents are processed as contents that are not in the managed-terminal 10.

Finally, it is requested to delete the harmful contents determined harmful contents (S418). The managed-terminal 10 receiving the request of deletion deletes the corresponding harmful contents (S420).

Although the present invention has been described with reference to the exemplary embodiments illustrated in the drawings, those are only examples and may be changed and modified into other equivalent exemplary embodiments from the present invention by those skilled in the art. Therefore, the technical protection range of the present invention should be determined by the following claims.

What is claimed is:

1. A method of remotely controlling harmful contents, comprising:
storing connection information of a managed-terminal and connection information of a managing-terminal in a database unit by using an administrative server, by transmitting the connection information to the administrative server by using the managed-terminal;
analyzing, by the managed-terminal, contents stored in the managed-terminal and creating an analysis result on the contents;
requesting, by the managed-terminal, the connection information of the managing-terminal to the administrative server;
transmitting, by the managed-terminal, the analysis result on the contents to the managing-terminal by using the connection information of the managing-terminal transmitted from the administrative server; and
processing, by the managed-terminal, the contents in accordance with a processing request for the contents transmitted from the managing-terminal.

2. The method of claim 1, further comprising storing, by the managed-terminal, the analysis result on the contents in the database unit by transmitting the analysis result to the administrative server.

3. The method of claim 1, wherein the processing of contents restricts access to harmful contents.

4. The method of claim 1, wherein the processing of contents deletes harmful contents.

5. The method of claim 1, wherein the processing of contents permits access to harmless contents.

6. The method of claim 1, wherein the managed-terminal prevents harmful contents from being listed in a file list.

7. The method of claim 1, wherein the managed-terminal updates the connection information of the managed-terminal every time a network area is changed, by transmitting the connection information to the administrative server.

8. The method of claim 1, wherein the managed-terminal transmits and registers phone numbers of the managing-terminal and the managed-terminal and IP information of the managed-terminal to the administrative server, and
the administrative server associates and stores the phone numbers of the managing-terminal and the managed-terminal and the IP information of the managed-terminal.

9. The method of claim 1, wherein the analysis result on the contents includes any one or more of the total number of analyzed contents, the analysis statistical information on the number of contents analyzed as obscene contents, and the thumbnail information on the contents for rechecking the analysis result.

10. The method of claim 1, wherein the managed-terminal transmits the analysis result on the contents to the administrative server and the administrative server stores the analysis result in the database unit.

11. A method of remotely controlling harmful contents, comprising:
storing connection information of a managing-terminal and connection information of a managed-terminal in a database unit by using an administrative server, by transmitting the connection information to the administrative server by using the managing-terminal;
requesting, by the managing-terminal, the connection information of the managed-terminal to the administrative server, when the managing terminal receives an analysis result on contents stored in the managed-terminal from the managed-terminal; and
requesting, by the managing-terminal, the managed-terminal to process the contents in accordance with the analysis result on the contents by using the connection information of the managed-terminal transmitted from the administrative server.

12. The method of claim 11, wherein the requesting of processing the contents requests access restriction to harmful contents.

13. The method of claim 11, wherein the requesting of processing the contents requests deletion of harmful contents.

14. The method of claim 11, wherein the requesting of processing the contents requests permission to access to harmless contents.

15. The method of claim 11, wherein the managing-terminal updates the connection information of the managing-terminal every time a network area is changed, by transmitting the connection information to the administrative server.

16. The method of claim 11, wherein the managing-terminal transmits and registers phone numbers of the managed-terminal and the managing-terminal and IP information of the managing-terminal to the administrative server, and
the administrative server associates and stores the phone numbers of the managed-terminal and the managing-terminal and the IP information of the managing-terminal.

17. The method of claim 11, wherein the analysis result on the contents includes any one or more of the total number of analyzed contents, the analysis statistical information on the number of contents analyzed as obscene contents, and the thumbnail information on the contents for rechecking the analysis result.

18. The method of claim 11, wherein the managing-terminal checks summarized information according to the analysis result on the contents and corrects errors in the analysis result on the contents through thumbnail information on the contents.
